(19) United States
(12) Patent Application Publication
(10) Pub. No.: US 2023/0068979 A1
(43) Pub. Date: Mar. 2, 2023

(54) INFORMATION PROCESSING APPARATUS, DATA PROCESSING SYSTEM, CONTROL METHOD OF INFORMATION PROCESSING APPARATUS, AND STORAGE MEDIUM

(71) Applicant: CANON KABUSHIKI KAISHA, Tokyo (JP)

(72) Inventor: Hiroaki Kobayashi, Tokyo (JP)

(21) Appl. No.: 17/881,669

(22) Filed: Aug. 5, 2022

(30) Foreign Application Priority Data
Aug. 24, 2021 (JP) 2021-136504

(51) Int. Cl. G06F 3/12

(52) U.S. Cl. CPC G06F 3/1257; G06F 3/1256; G06F 3/1255; G06F 3/1205

(57) ABSTRACT

Provided is a method for controlling an information processing apparatus transmitting print data and a print setting to an image forming apparatus, the method comprising storing a plurality of print settings and displaying a selection screen to select a print setting for print data transmitted to the image forming apparatus among the stored plurality of print settings to receive the selected print setting by a user, wherein the plurality of print settings displayed on the selection screen are controlled based on a type of the print data.

### BACKGROUND OF THE INVENTION

### Field of the Invention

The present invention relates to an information processing apparatus that registers print settings in advance and instructs an image forming apparatus to perform print processing using the print settings.

### Description of the Related Art

In recent years, with the spread of high-performance mobile terminals called smart phones, opportunities to use print functions of an image forming apparatus from the mobile terminals are increasing. A user searches the image forming apparatus on the LAN, adds a file selected by the user and various print setting information (for example, the number of copies to be printed and color information), and configures the file as a print job. By transmitting the print job to the image forming apparatus having a printer function, a series of processes necessary for printing can be executed by the mobile terminal. At this time, by saving and registering various print setting information, the print setting frequently used by the user can be reused.

Japanese Patent Application Laid-Open No. 2015-207875 discloses a technique for determining in advance a print setting to be used in accordance with an application in a mobile terminal when using a print function of an image forming apparatus from the mobile terminal.

In the mobile terminal described in Japanese Patent Application Laid-Open No. 2015-207875, it is possible to store print setting information (hereinafter referred to as “favorite print settings”) when printing is performed on an image forming apparatus for each application for which printing is performed. The user registers the print setting information in advance according to types of the file to be printed and the use, and selects the registered favorite print setting when printing, so that the file can be printed with the registered print setting. However, if all the registered favorite print settings are displayed when the favorite print settings are selected, user operation becomes complicated because the favorite print settings that are not likely to be used depending on the file to be printed are displayed.

### SUMMARY OF THE INVENTION

According to an aspect of the present invention, a method for controlling an information processing apparatus transmitting print data and print setting to an image forming apparatus, the method comprises storing a plurality of print settings, and displaying a selection screen to select print setting for print data transmitted to the image forming apparatus among the stored the plurality of print settings to receive the selected print setting by a user, wherein the plurality of print settings displayed on the selection screen are controlled based on a type of the print data.

Further features of the present invention will become apparent from the following description of exemplary embodiments with reference to the attached drawings.

### BRIEF DESCRIPTION OF THE DRAWINGS

FIG. 1 is a block diagram showing a data processing system configuration according to an embodiment of the present invention.

FIG. 2 is a block diagram showing a hardware configuration of the data processing apparatus according to the embodiment of the present invention.

FIG. 3 is a block diagram showing a hardware configuration of the image forming apparatus according to the embodiment of the present invention.

FIG. 4 is a block diagram showing a software configuration of the data processing apparatus according to the embodiment of the present invention.

FIG. 5 is a block diagram showing a software configuration of the image forming apparatus according to the embodiment of the present invention.

FIG. 6A is a screen example of print instruction processing in the data processing apparatus according to the embodiment of the present invention.

FIG. 6B is a screen example of print instruction processing in the data processing apparatus according to the embodiment of the present invention.

FIG. 6C is a screen example of print instruction processing in the data processing apparatus according to the embodiment of the present invention.

FIG. 6D is a screen example of print instruction processing in the data processing apparatus according to the embodiment of the present invention.

FIG. 7 is a flowchart of display processing of a print setting selection screen according to the embodiment of the present invention.

FIG. 8A is a screen example of a print setting registration of the data processing apparatus according to the embodiment of the present invention.

FIG. 8B is a screen example of a print setting registration of the data processing apparatus according to the embodiment of the present invention.

FIG. 9A shows a print setting table of the data processing apparatus according to the embodiment of the present invention.

FIG. 9B shows a print setting table of the data processing apparatus according to the embodiment of the present invention.

FIG. 9C shows a print setting table of the data processing apparatus according to the embodiment of the present invention.

FIG. 10A is a print setting selection screen (favorite print setting) according to the embodiment of the present invention.

FIG. 10B is a print setting selection screen (favorite print setting) according to the embodiment of the present invention.

FIG. 11 is a screen for calling a print from another application according to another embodiment of the present invention.

### DESCRIPTION OF THE EMBODIMENTS

Hereinafter, exemplary embodiments of the present invention will be described in detail with reference to the drawings. However, the constituent elements described in the embodiments are merely examples, and the scope of the present invention is not intended to be limited to them.

### First Embodiment

[Overall Configuration of the Data Processing System]

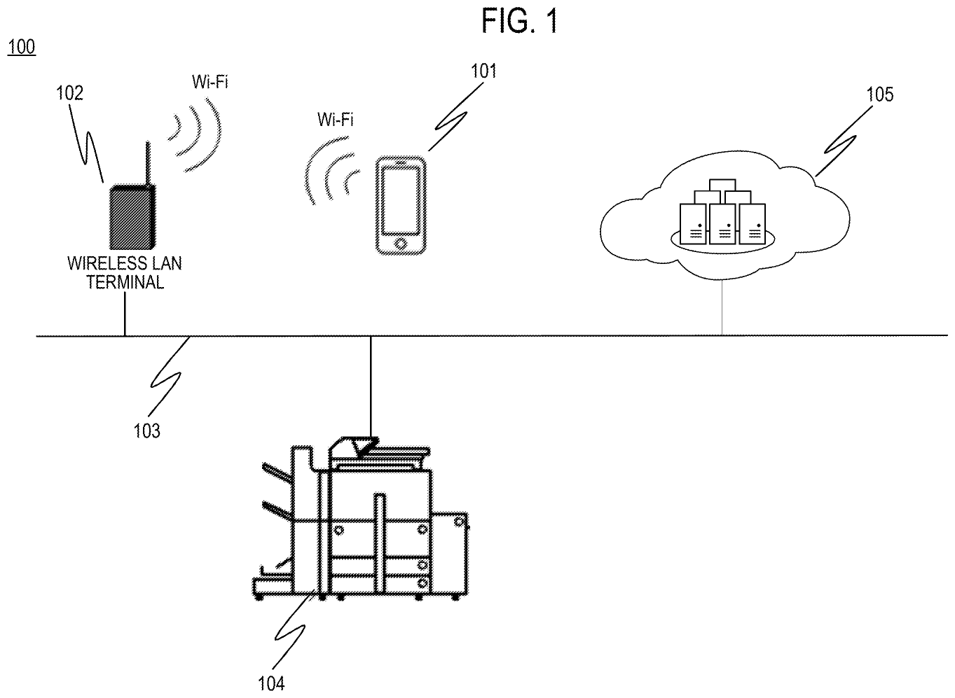

FIG. 1 is a block diagram showing the overall configuration of a data processing system according to the present embodiment.

The data processing system 100 comprises a data processing apparatus 101, a wireless LAN terminal 102, an image forming apparatus 104, and a cloud server 105, and the apparatuses are connected via a network 103.

The data processing apparatus 101, which is an information processing device, is a mobile terminal such as a smart phone, and may have an operating system for a small terminal and a program for controlling voice and data communications. Alternatively, the personal computer may not be provided with voice control, position detection control, cellular phone data communication, etc. The data processing apparatus 101 is connected to the network 103 via the wireless LAN terminal 102.

The wireless LAN terminal 102 is a master device of a wireless LAN having a general network router function, and provides a wireless LAN through Wi-Fi in a home or an office.

The image forming apparatus 104 is a digital multifunction device having various job execution functions such as a printer function, a copy function, a scanner function, and a fax transmission function. By operating the data processing apparatus 101, the user can instruct the image forming apparatus 104 to execute the job and execute various functions of the image forming apparatus 104.

The cloud server 105 manages data used in the data processing apparatus 101 and the image forming apparatus 104, which are information processing apparatuses, and performs expansion processing of various functions through the network 103. Although the image forming apparatus 104 and the cloud server 105 are connected with the network 103 in this embodiment, they may be wirelessly connected using the wireless LAN terminal 102 in the same manner as the data processing apparatus 101.

Further, the data processing apparatus 101 and the image forming apparatus 104 can perform short-range wireless communications via wireless signals such as NFC (Near Field Communication) and BLE (Bluetooth Low Energy). The image forming apparatus 104 has information (such as an IP address and a MAC address) for making a wireless LAN connection with the data processing apparatus 101 in an NFC communication section and a BLE communication section, which will be described later, and the data processing apparatus 101 acquires the connection information by short-range wireless communication. Then, the communications between the data processing apparatus 101 and the image forming apparatus 104 are started based on the acquired information. For example, wireless LAN communications between the data processing apparatus 101 and the image forming apparatus 104 are established by switching from connection information acquired by the short-range wireless communications of NFC or BLE to the wireless LAN communications of Wi-Fi or the like (called handover) between devices.

[Hardware Configuration of the Data Processing Apparatus]

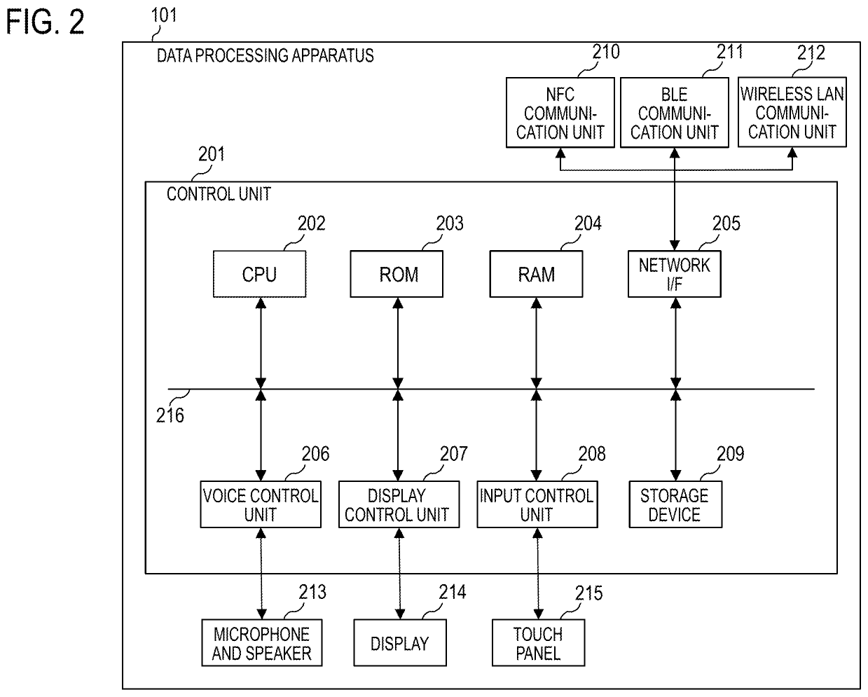

FIG. 2 is a block diagram showing a hardware configuration of the data processing apparatus 101 according to the present embodiment.

The data processing apparatus 101 has a control unit 201. The control unit 201 controls various communication units of an NFC communication unit 210, a BLE communication unit 211, and a wireless LAN communication unit 212, and various UI units of a microphone and a speaker 213, a display 214, and a touch panel 215.

The control unit 201 includes a CPU 202, a ROM 203, a RAM 204, a network I/F 205, a voice control unit 206, a display control unit 207, an input control unit 208, and a storage device 209, which are connected by a system bus 216.

The CPU 202 controls the entire system of the data processing apparatus 101.

The ROM 203 stores the operating system of the data processing apparatus 101 and applications for controlling voice and data communications, and the CPU 202 executes various programs.

The RAM 204 is a memory, and is a work memory area in which the CPU 202 deploys and executes various programs and data stored in the ROM 203 and the storage device 209.

The storage device 209 is a nonvolatile storage device (for example, an EPROM), and stores various operation mode settings, operation logs, and the like that need to be retained even after the data processing apparatus 101 is restarted.

The network I/F 205 is connected to the NFC communication unit 210, the BLE communication unit 211, and the wireless LAN communication unit 212, and performs various wireless communication controls with the image forming apparatus 104 and the cloud server 105.

The voice control unit 206 performs input/output control of voice data via the microphone and the speaker 213. The display control unit 207 controls the output of image data to be displayed on the display 214. The input control unit 208 performs input control of information instructed by a user through a button or the touch panel 215. The voice control unit 206, the display control unit 207, and the input control unit 208 are used to provide the user with various applications to be executed by the data processing apparatus 101.

[Hardware Configuration of the Image Forming Apparatus]

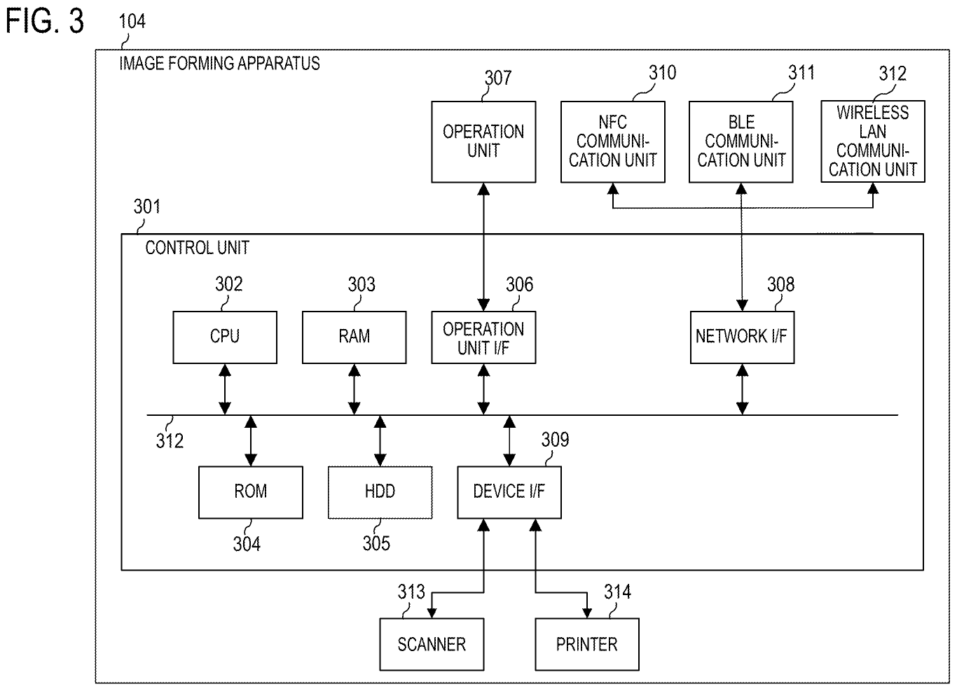

FIG. 3 is a block diagram showing a hardware configuration of the image forming apparatus 104 according to the present embodiment.

The image forming apparatus 104 has a control unit 301, and the control unit 301 controls various communication units of an NFC communication unit 310, a BLE communication unit 311, and a wireless LAN communication unit 312, an operation unit 307, a scanner 313, and a printer 314.

When the user uses the copy function, the control unit 301 controls the scanner 313 to acquire image data of the original, and controls the printer 314 to print and output the image on the papers. When the user uses the scanning function, the control unit 301 controls the scanner 313 to acquire image data of the original, converts the image data into code data, and transmits the code data to the data processing apparatus 101, the cloud server 105, or the like via the network 103. When the user uses the print function, the control unit 301 receives image data (code data) from the data processing apparatus 101 and the cloud server 105 via the network 103. The control unit 301 converts the received image data into the print data to transmit the image data to the printer 314. The printer 314 prints an image on the paper based on the received print data and outputs the printed paper.

The image forming apparatus 104 also has a FAX receiving function for receiving and printing data from an ISDN or the like and a FAX transmitting function for transmitting scanned data to the ISDN or the like. An instruction to execute processing in each of these functions is called a job, and the image forming apparatus 104 executes predetermined processing according to the job corresponding to each function.

The control unit 301 comprises a CPU 302, a RAM 303, a ROM 304, an HDD 305, an operation unit I/F 306, a network I/F 308, and a device I/F 309, which are connected via a system bus 315.

The CPU 302 controls the entire system of the image forming apparatus 104. The RAM 303 is a system work memory used for the operation of the CPU 302, and is a memory for temporarily storing image data and setting data. The RAM 303 also contains programs and data such as an operating system, system software, and application software. Further, scan image data read by the scanner 313 or print image data received from the data processing apparatus 101 via the network 103 are stored. The ROM 304 stores the boot program of the system. The hard disk drive (HDD) 305 stores an operating system, system software, application software, image data, setting data, etc.

The operation unit I/F 306 is an interface unit with the operation unit 307, and outputs information to be displayed on the operation unit 307 to the operation unit 307. Information inputted by a user is received from an operation unit 307.

The network I/F 308 is connected to the NFC communication unit 310, the BLE communication unit 311, and the wireless LAN communication unit 312 to perform various wireless communication controls with the data processing apparatus 101 and the cloud server 105. The wireless LAN communication unit 312 forms a wireless LAN (Wi-Fi) with the data processing apparatus 101 via the network 103 and the wireless LAN terminal 102. The NFC communication unit 310 and the BLE communication unit 311 form short-range wireless communications with the data processing apparatus 101 via wireless signals. The image forming apparatus 104 transmits and receives job setting information and image data to and from the data processing apparatus 101 via the network I/F 308, and executes jobs upon receiving execution commands for various functions of the image forming apparatus 104.

The device I/F 309 connects the control unit 301 to the scanner 313 and the printer 314 for scanning and printing image data, and inputs and outputs image data.

[Software Configuration of the Data Processing Apparatus]

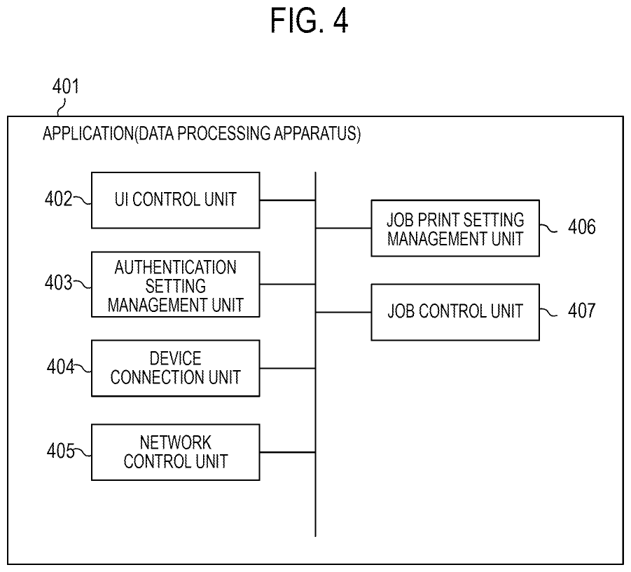

FIG. 4 is a block diagram showing a software configuration of the data processing apparatus 101 according to the present embodiment.

An application 401 is software executed by the CPU 202 of the data processing apparatus 101 and stored in the ROM 203.

A user interface (UI) control unit 402 receives the job setting information input by the user on the touch panel 215 and transmits the job setting information to a job print setting management unit 406 via the input control unit 208. The UI control unit 402 receives responses from the job print setting management unit 406 and a job control unit 407 and outputs them to the display 214 via the display control unit 207. Further, the UI control unit 402 receives the authentication information input by the user on the touch panel 215 and transmits the authentication information to an authentication setting management unit 403 via the input control unit 208.

The authentication setting management unit 403 transmits authentication information to a network control unit 405 based on the user information received from the UI control unit 402. The authentication information is used for authentication processing in the image forming apparatus 104 described later via the network 103.

A device connection unit 404 establishes short-range wireless communications of NFC and BLE of the data processing apparatus 101 and the image forming apparatus 104 and wireless LAN communication via the network 103. For example, in the case of NFC, the user brings the NFC communication unit 210 of the data processing apparatus 101 close to the NFC communication unit 310 of the image forming apparatus 104, and brings them into contact with each other to start short-range wireless communications. In the case of BLE, when the user brings the BLE communication unit 211 of the data processing apparatus 101 closer to the BLE communication unit 311 of the image forming apparatus 104, and the device connection unit 404 determines that the strength of the BLE is within a certain strength or more, the short-range wireless communications are started. As described above, when the user brings the data processing apparatus 101 close to the communication unit of the NFC or BLE of the image forming apparatus 104 (referred to as a touch operation), the device connection unit 404 acquires the device information of the image forming apparatus 104. The wireless LAN connection with the image forming apparatus 104 via the network 103 is started based on the acquired equipment information. It should be noted that the transmission and reception of subsequent print data may be continued by using NFC and BLE.

The network control unit 405 transmits job settings, job execution instruction commands, image data, user authentication information, and the like to the image forming apparatus 104 via the network 103. Further, the network control unit 405 receives the job setting information stored in the image forming apparatus 104 via the network 103.

The job print setting management unit 406 stores and manages the print setting information inputted by the user via the UI control unit 402 as favorite print settings in the RAM 204 or the storage device 209. The job control unit 407 generates job execution instruction information from a print file selected by a user and favorite print settings registered by the job print setting management unit 406, and transmits a job execution request to the image forming apparatus 104 through the network 103. The job control unit 407 acquires a job execution status and a operating status of the devices of the scanner 313 and the printer 314 from the image forming apparatus 104 via the network 103, and transmits them to the UI control unit 402.

[Software Configuration of the Image Forming Apparatus]

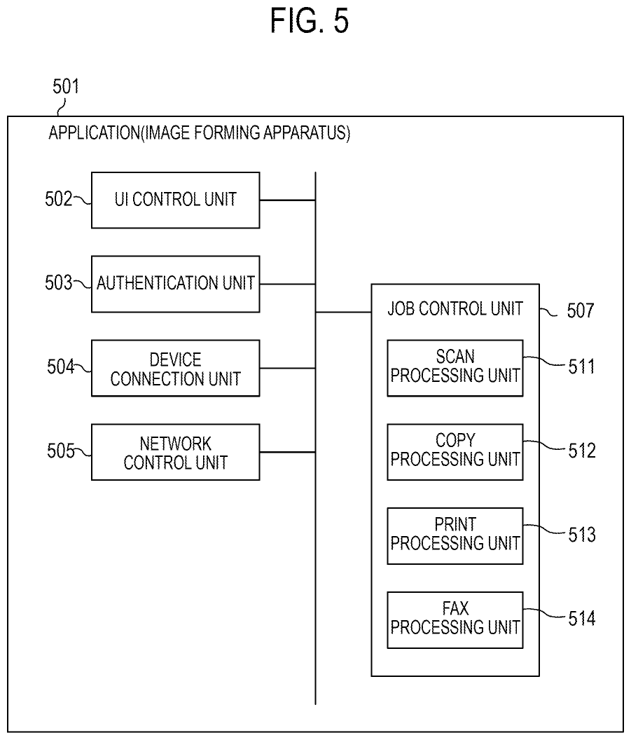

FIG. 5 is a block diagram showing a software configuration of the image forming apparatus 104 according to the present embodiment.

An application 501 is software executed by the CPU 302 of the image forming apparatus 104 and stored in the RAM 303.

A user interface (UI) control unit 502 receives an operation inputted by the user via the operation unit 307. The UI control unit 502 receives the response from a job control unit 507 and outputs it to the operation unit 307.

An authentication unit 503 performs user authentication processing based on the authentication information received from the data processing apparatus 101, and returns the result.

A device connection unit 504 performs handover by short-range wireless communications between the data processing apparatus 101 and the image forming apparatus 104 to establish wireless LAN communications via the network 103.

A network control unit 505 receives a job setting, a job execution instruction command, image data, user authentication information and the like from the data processing apparatus 101 via the network 103.

The job control unit 507 controls each processing unit of a scan processing unit 511, a copy processing unit 512, a print processing unit 513, and a fax processing unit 514 according to the received job setting to execute various jobs. At this time, the job control unit 507 receives the job execution request received from the data processing apparatus 101 via the network 103 to execute various jobs in accordance with the received job setting and job execution instruction. The job control unit 507 transmits the job execution status and the operating status of the devices of the scanner 313 and the printer 314 to the data processing apparatus 101 via the network 103.

[Print Operation Screen (the Data Processing Apparatus)]

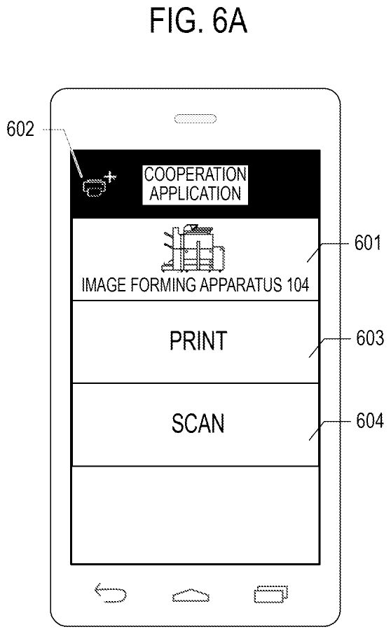

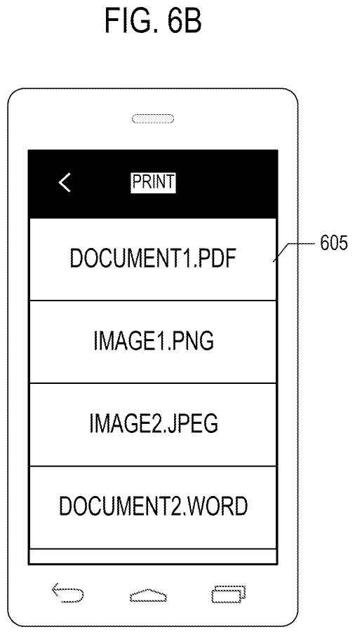

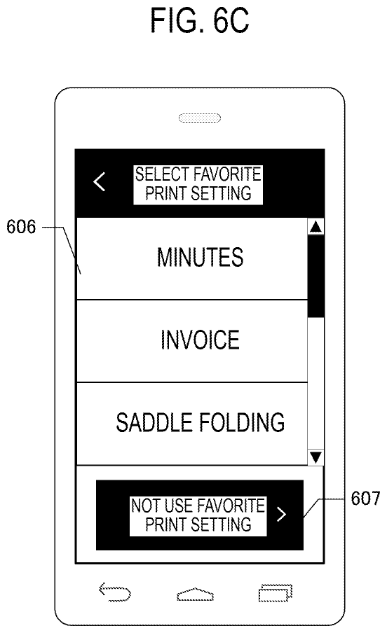

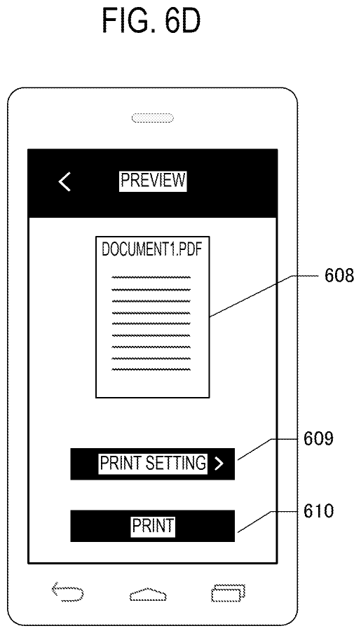

FIGS. 6A to 6D are examples of screens displayed by the print instruction processing in the data processing apparatus 101 according to the present embodiment.

When the icon of the application 401 is selected by user operation via the application list screen (also called “drawer”) or the home screen of the data processing apparatus 101, the CPU 202 starts the application 401. When the start processing is completed, the application 401 displays the top menu screen shown in FIG. 6A on the display 214 of the data processing apparatus 101.

First, the functions of the application 401 will be described using the top menu screen.

In an area 601, an MFP (Multi-Function Peripheral) of the currently selected link destination is displayed. In the present embodiment, as an example, the image forming apparatus 104 is designated as a cooperation destination. By selecting the area 601, the user can change the MFP of the link destination and confirm the state of the MFP of the link destination and the capability of the MFP.

An add-key 602 is a key that provides a function of registering a new MFP to be a link destination.

The user can use the add-key 602 to register an MFP as a new cooperation destination. The application 401 registers the information of the MFP instructed to be registered in the cooperation destination by the user operation in the device list and stores it in the storage device 209. The MFP registered in the device list can be selected as an MFP to be linked thereafter.

The application 401 can execute various cooperation functions in cooperation with an MFP (for example, the image forming apparatus 104) designated as a cooperation destination. A print-key 603 is a key used when image data and document data stored in the data processing apparatus 101 are transmitted to the MFP to which they are linked and printing is performed. A scan-key 604 is a key used to execute a scan cooperation function in which a document is scanned by the MFP of the cooperation destination and the data obtained by the scan is taken into the storage device 209 of the data processing apparatus 101.

Since the present invention relates to printing, a screen flow when the print-key 603 is pressed will be described below.

FIG. 6B shows an example of a document selection screen displayed after the print-key 603 is selected. The selection screen in FIG. 6B shows an example of a list display of documents and images stored in the data processing apparatus 101. When the CPU 202 detects that the information indicating the document or image is selected among items 605 displayed on the selection screen, the CPU changes the screen displayed on the display 214 to the favorite print setting selection screen.

FIG. 6C shows an example of a list of favorite print settings previously registered by the user.

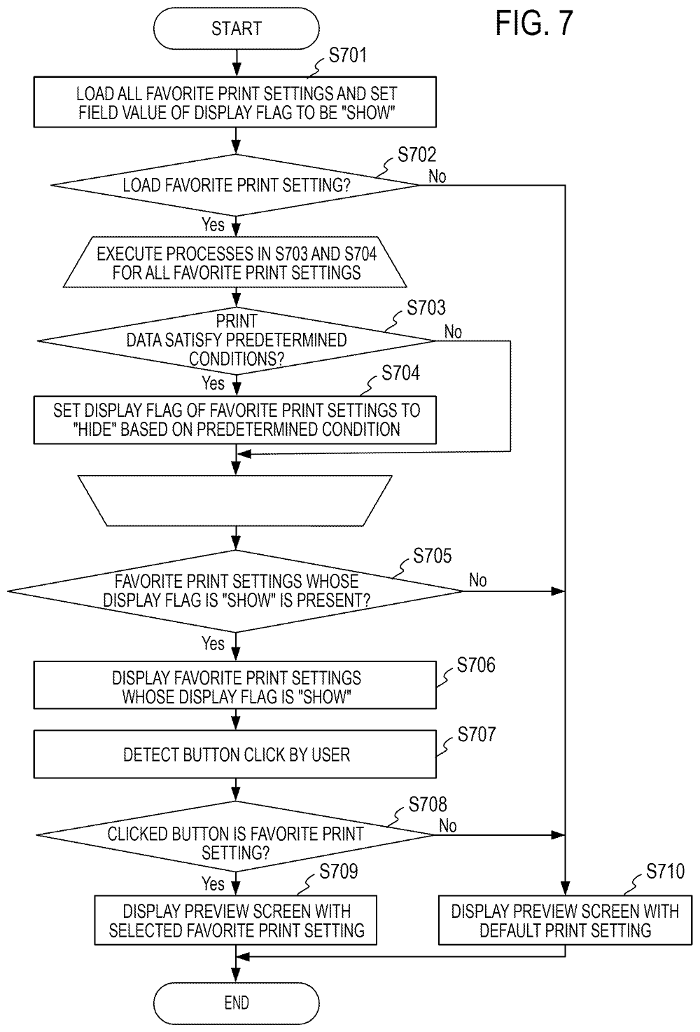

When the CPU 202 detects that information indicating a favorite print setting is selected among favorite print setting buttons 606 displayed on the favorite print setting selection screen, the CPU changes a screen to a preview screen in which the selected favorite print setting is set. The display control method of the favorite print setting will be described later with reference to FIG. 7. When the CPU 202 detects that the default print setting button 607 displayed on the favorite print setting selection screen is selected, the CPU changes a screen to a preview screen in which the print setting determined by default is set. When many favorite print settings are registered, a scroll bar is displayed on the right side of the screen, and the user scrolls the scroll bar to find the registered favorite print settings.

FIG. 6D shows an example of the preview screen. The CPU 202 displays a preview image for confirming print contents in an area 608 of the preview screen. The preview image displayed in the area 608 is generated based on the document and image data selected on the selection screen.

The CPU 202 may generate the preview image, or a cloud service (not shown) may be requested to generate the preview image, and the cloud service may generate the preview image.

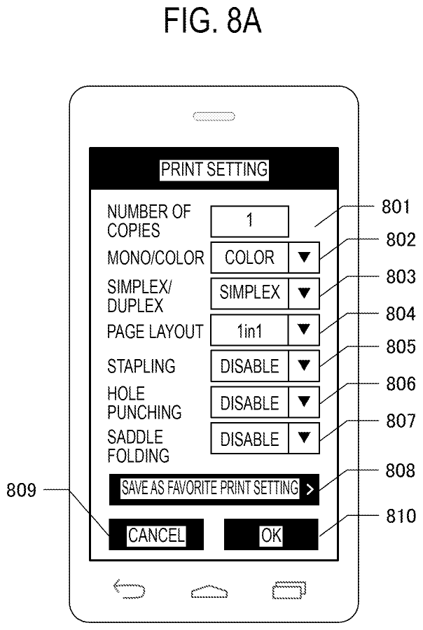

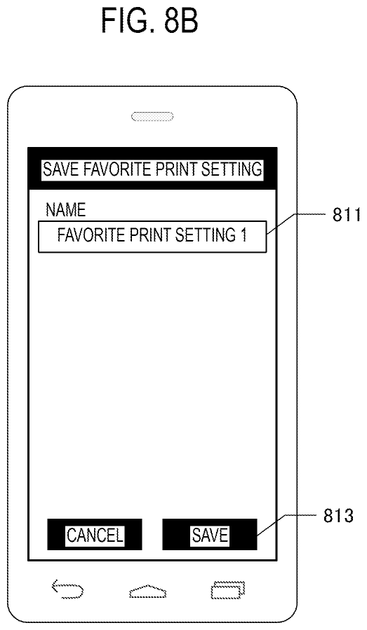

A print setting key 609 is a key for changing a screen to a print setting screen for displaying print settings of print data to be transmitted to the MFP. Details of the print setting screen will be described later with reference to FIGS. 8A and 8B. A print-key 610 is used for printing the selected document or image. When the CPU 202 detects that the print-key 610 is pressed by the user, the CPU transmits the document and image data displayed in preview as well as the currently set print setting as a set to the image forming apparatus 104. The image forming apparatus 104 prints the document and image data based on the print data and the print setting.

[Control Processing for Displaying Screen]

Next, a specific display control process for displaying the favorite print setting buttons 606 on the favorite print setting selection screen in FIG. 6C will be described with reference to the flowchart of FIG. 7. FIG. 7 is a flowchart showing the control of the data processing apparatus 101.

Each operation (step) shown in the flowchart of FIG. 7 is realized by the CPU 202 reading out a program stored in the ROM 203 or the storage device 209 into the RAM 204 to execute the program for realizing each control module.

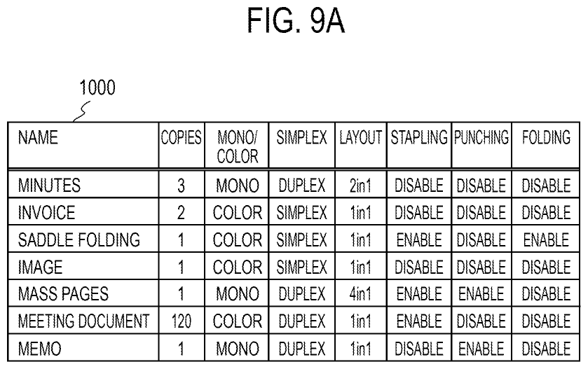

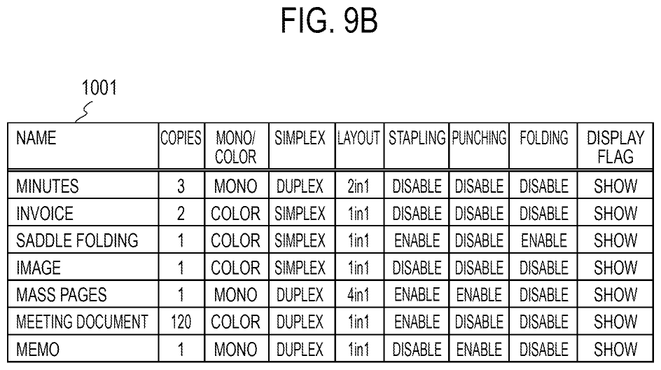

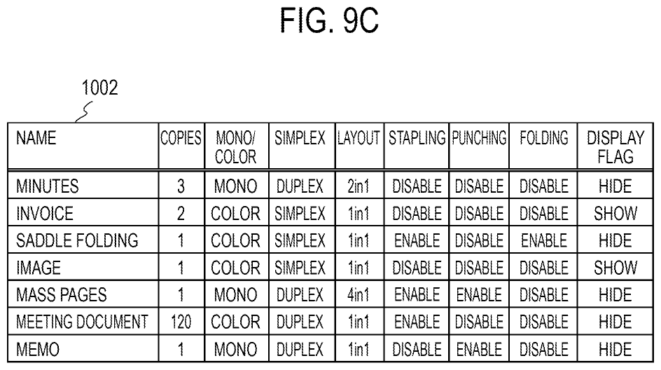

In step S701, the CPU 202 refers to the favorite print setting table stored in the storage device 209, reads out the favorite print setting table into the RAM 204, and sets each field value of the display flag in the favorite print setting table to “show” as a default setting value. In the present embodiment, the favorite print setting table stored in the storage device 209 is shown in FIG. 9A. FIG. 9B shows a favorite print setting table that is read into the RAM 204 in step S701 and has all the field values of the display flags of all the favorite print settings as “show”.

In step S702, the CPU 202 determines whether or not the favorite print setting has been read into the RAM 204 in step S701. If even one favorite print setting has been read out, that is, if any favorite print setting has been registered, the process proceeds to step S703. On the other hand, if no favorite print setting has been read out, the process proceeds to step S710 to display the preview screen for the default print setting.

In step S703, the CPU 202 determines whether the print data selected by the user in FIG. 6D satisfies a predetermined condition. Here, the predetermined condition is, for example, whether or not the print data selected by the user is image data such as png/jpeg, or whether or not the print data is a document and the number of pages is a single. Thus, the display setting is determined so that the favorite print setting which is likely not to be used is not displayed according to the print data selected by the user.

If it is determined in step S703 that the predetermined condition is satisfied, the process proceeds to step S704. On the other hand, if it is determined that the predetermined condition is not satisfied, the process proceeds to step S705.

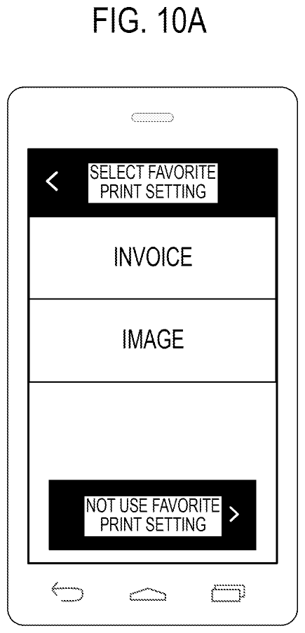

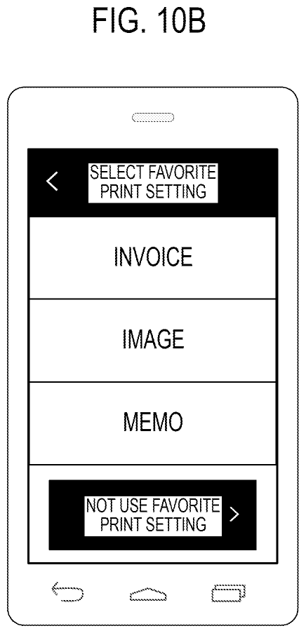

In step S704, the CPU 202 switches the field value of the corresponding display flag of the favorite print setting read as the display setting in the RAM 204 in step S701 to “hide” in accordance with the condition satisfied in step S703, and stores the field value in the RAM 204. For example, if it is determined in step S703 that a type of the print data is image data, the display flag of the setting that is highly likely not to be used for the image data is switched to “hide” and stored in the RAM 204. More specifically, the condition is satisfied by the favorite print setting including using monochrome in color/monochrome setting, not 1 in 1 in the aggregation setting, using staples in the staple setting, using saddle folding in the saddle folding processing setting, and punching in the punching processing setting. Because it is considered that the user does not want to print the image data in monochrome or by aggregating a plurality of pages into one page or print with staples, these favorite print settings correspond to the condition. FIG. 9C shows the favorite print setting table read into the RAM 204 after the processing in step S704. As a result, the display of the favorite print setting selection screen displayed when the type of print data is image data such as png/jpeg is restricted as shown in FIG. 10A (“invoice” and “image” are displayed as selection candidates). Here, the type of print data may be determined from the extension of the file. In the above case, if the extension is png, jpeg, or the like, it is determined that the print data is image data.

When it is determined that the type of print data is a document and the number of pages is a single, the display flag of the document with a high possibility of not being used is switched to “hide” and stored in a RAM 204. More specifically, the condition is satisfied by the favorite print setting including not 1 in 1 in the aggregation setting, using staples in the staple setting, and using saddle folding in the saddle folding processing setting. Thus, the favorite print setting selection screen displayed when the print data is a document and the number of pages is a single is limited in that it is displayed as shown in FIG. 10B (“invoice”, “image”, and “memo” are displayed as selection candidates).

In step S705, the CPU 202 determines whether there is a favorite print setting stored in the RAM 204 to be displayed. If there is a favorite print setting including the display flag of “show”, the process proceeds to step S706. On the other hand, if there is a favorite print setting including the display flag of “hide”, the process proceeds to step S709.

In step S706, the CPU 202 restricts the display of the favorite print setting including the display flag of “hide” on the favorite print setting selection screen (FIG. 6C) to display the favorite print setting including the display flag of “show” among the favorite settings read into the RAM 204 in step S701.

In step S707, the CPU 202 detects that the favorite print setting buttons 606 or the default print setting button 607 is pressed.

In step S708, the CPU 202 determines whether the button pressed in step S707 is the favorite print setting buttons 606 or the default print setting button 607. If it is determined that the favorite print setting button 606 is pressed, the process proceeds to step S709. On the other hand, if it is determined that the default print setting button 607 is pressed, the process proceeds to step S710.

In step S709, the CPU 202 sets the favorite print setting pressed by the user in step S707 and opens the preview screen (FIG. 6D), and the display control process ends.

In step S710, the CPU 202 opens the preview screen (FIG. 6D) with the predetermined default print setting, and the display control process ends. In the present embodiment, the predetermined default print setting is that the number of copies is 1, monochrome/color setting is color, simplex/duplex setting is simplex, aggregation setting is 1 in 1, stapling setting is disabled, hole punching setting is disabled, and saddle folding setting is disabled.

FIG. 8A is an example of a print setting screen displayed when the print setting key 609 of FIG. 6D is pressed in the data processing apparatus 101 according to the present embodiment. Each of areas 801 to 807 shows a set value for the print setting item. The user can change the print setting when transmitting the print data to the image forming apparatus 104 by changing the set value of the print setting item to be changed in the areas 801 to 807. If the preview screen is opened with the favorite print setting in step S709, the print setting screen is displayed with the favorite print setting selected by the user. A favorite print setting registration key 808 registers the currently displayed print setting as the favorite print setting. When the CPU detects that the user presses the favorite print setting registration key 808, the CPU 202 displays the favorite print setting registration screen shown in FIG. 8B. When the CPU detects that a cancel-key 812 is pressed by the user, the CPU 202 cancels the favorite print setting registration and returns to the print setting screen of FIG. 8A. When the CPU detects that a save-key 813 is pressed by the user, the CPU 202 stores the contents displayed in the areas 801 to 807 in the storage device 209 with the favorite print setting name entered by the user in an item 811, and returns to the print setting screen of FIG. 8A. The registered favorite print setting name is displayed on the favorite print setting selection screen in FIG. 6C. When the CPU 202 detects that an OK-key 810 is pressed by the user, the CPU returns the display to the preview screen with the set value of the areas 801 to 807.

As described above, according to the present embodiment, when the data processing apparatus 101 instructs the image forming apparatus 104 to perform printing, the list of print settings displayed on the favorite print setting selection screen can be switched according to the file to be printed.

### Second Embodiment

In the first embodiment, the method has been described in which the application 401 alone selects the printing data in the data processing apparatus 101 to operate the print instruction. In the present embodiment, a method of operating the print instruction from an application other than the application 401 by using a function of calling the application 401 (e.g., Open In) will be described.

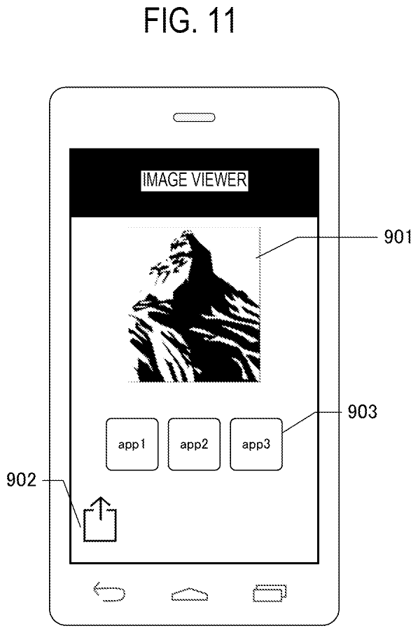

FIG. 11 shows an example of a screen related to an image viewer application 900 installed in the data processing apparatus 101 according to the present embodiment.

In the present embodiment, the image viewer application 900 is an application that accesses the cloud server 105 and displays image data stored in the cloud. The CPU 202 reads data stored in the cloud and stores the data in the RAM 204, which is used for preview display and delivery to other applications.

The preview of the image stored in the RAM 204 is displayed in an area 901. A different application list display button 902 is a button used when calling up another application from the image viewer application. An application call button 903 is used to call the application corresponding to the pressed button. When the CPU 202 detects that the user presses the application call button 903, the CPU passes a path of the image stored in the RAM 204 to the corresponding application and starts the corresponding application.

When the application 401 is called by the application call button 903, the CPU 202 executes the operations shown in the flowchart of FIG. 7 and displays the favorite print setting selection screen of FIG. 6C.

According to this embodiment, when the application 401 is called from the application installed in the data processing apparatus 101 for a print instruction, the list of print settings can be switched to the favorite print setting selection screen according to the print data.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-136504, filed Aug. 24, 2021, which is hereby incorporated by reference herein in its entirety.

What is claimed is:

1. A method for controlling an information processing apparatus transmitting print data and print setting to an image forming apparatus, the method comprising:
storing a plurality of print settings; and
displaying a selection screen to select a print setting for print data transmitted to the image forming apparatus among the stored plurality of print settings to receive the selected print setting by a user,
wherein the plurality of print settings displayed on the selection screen are controlled based on a type of the print data.

2. The method according to claim 1, wherein the type of the print data is a file extension.

3. The method according to claim 2, wherein if the file extension corresponds to a file extension for image data, the selection screen does not display print settings including at least one of a setting for monochrome printing, a setting for aggregating a plurality of pages into one page, a setting using a staple, and a setting for saddle folding.

4. The method according to claim 1, wherein the type of the print data is determined based on the number of pages.

5. The method according to claim 4, wherein if the number of pages is a single page, the selection screen does not display print settings including at least one of a setting for aggregating a plurality of pages into one page, a setting using a staple, and a setting for saddle folding.

6. The method according to claim 1, further comprising specifying the print data,
wherein the print data transmitted to the image forming apparatus is the specified print data or the print data transmitted from an application deployed on the information processing apparatus.

7. The method according to claim 1, wherein a preview screen of the print data is displayed based on the print setting selected on the selection screen.

8. The method according to claim 1, wherein a default setting is used for the print data if there is no print setting displayed on the selection screen among the plurality of print settings controlled based on the type of the print data.

9. The method according to claim 1, wherein the print settings are restricted on the selection screen based on the type of print data.

10. The method according to claim 1, wherein the selection screen is displayed in response to selecting the print data transmitted to the image forming apparatus.

11. The method according to claim 1, wherein the print setting selected on the selection screen and the print data are transmitted to the image forming apparatus.

12. The method according to claim 1, wherein the print setting includes a setting value corresponding to each of the plurality of settings.

13. An information processing apparatus transmitting print data and a print setting to an image forming apparatus, the information processing apparatus comprising:
a memory; and
at least one processor in communication with the memory, wherein the at least one processor is configured to perform:
storing a plurality of print settings; and
displaying a selection screen to select a print setting for print data transmitted to the image forming apparatus among the stored plurality of print settings to receive the selected print setting by a user,
wherein the plurality of print settings displayed on the selection screen are controlled based on a type of the print data.

14. A non-transitory computer-readable storage medium storing program to cause a computer to perform a method for controlling an information processing apparatus transmitting print data and a print setting to an image forming apparatus, the method comprising:
storing a plurality of print settings; and
displaying a selection screen to select a print setting for print data transmitted to the image forming apparatus among the stored plurality of print settings to receive the selected print setting by a user,
wherein the plurality of print settings displayed on the selection screen are controlled based on a type of the print data.
